(19) United States
(12) Patent Application Publication
(10) Pub. No.: US 2005/0146888 A1
(43) Pub. Date: Jul. 7, 2005

(54) Tailgate lighting system

(76) Inventor: Keith E. Metcalf, Huntingburg (IN)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/031,199

(22) Filed: Jan. 6, 2005

Related U.S. Application Data
(60) Provisional application No. 60/534,827, filed on Jan. 6, 2004.

(51) Int. Cl. B60Q 1/30

(52) U.S. Cl. 362/541; 362/485; 362/543

(57) ABSTRACT

A lighting system that attaches to the tailgate of a vehicle for illuminating the tailgate. The lighting system includes at least one lighting element, which lighting element can be electrically connected to the standard light system of the vehicle, so that when lights of the vehicle are turned on, the at least one lighting element illuminates. The lighting system can further include a sensor-means, wherein the sensor means activates the lighting system to illuminate the lighting element upon the happening of a selected event, such as lowering the tailgate, or at darkness, dusk, or times of severe weather conditions, for example. The lighting element may be a single component, or, may consist of a plurality of lighting elements selectively positioned along the length of the top end portion of the tailgate.

### CROSS REFERENCES TO RELATED APPLICATIONS

U.S. Provisional Application for Patent No. 60/534,827, filed 01/06/2004, with title “Tailgate Lighting System” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable.

### BACKGROUND OF THE INVENTION

1. Field of the Invention

This invention relates to a lighting system for illuminating the tailgate of a vehicle such as a pickup truck whether the tailgate is in a raised position or a lowered position.

2. Brief Description of Prior Art

Virtually all vehicles are required by law to have safety or driving lights which must be utilized during darkness. This requirement applies to night driving but may also apply to a period of time during the transition period known as dusk as well as during times of severe weather conditions.

Lights on the rear of the vehicle help the driver following the subject vehicle to navigate not only the location of the vehicle, but also helps determine the location of the rear end portion of the vehicle to avoid driving too close. Vehicle lighting for the rear end portion of a pickup truck is more problematic than most vehicles. By their very nature, trucks are constantly being loaded and unloaded. When loaded, the tailgate of the pickup truck is often left in an open position thereby extending the length of the pickup truck. When the tailgate, and particularly the end of the tailgate that extends from the bed of the pickup truck when in an open position is not illuminated, which is generally the case, the driver of the vehicle following the pickup is often unable to determine the location of the rear end portion of the pickup truck, especially during darkness. This results in conditions which are unsafe for all concerned.

Prior art methods for illuminating the bed of a pickup truck is known in the art. Such methods include mounting lights on the cab of the truck, however such lighting systems generally fail to illuminate the entire truck bed, especially the rear end portion of the bed. U.S. Pat. No. 5,759,051 discloses a lighting system to be mounted between the side walls of the truck bed against the front wall of the bed nearest the rear wall of the cab of the truck. However, this lighting system again fails to illuminate the entire truck bed and in particular the rear end portion of the bed farthest from the cab of the truck. Further, such lighting system is generally positioned on the side walls of the truck bed where tool boxes or cargo boxes are popularly mounted. Further, installation of the system reduces the amount of available space in the back of the truck bed closest to the cab.

U.S. Pat. No. 6,238,068 discloses a lighting system having a plurality of lamps mounted along the underside of the side rails of the pickup truck. Such system further including battery means for providing power to the plurality of lamps. Again, the lighting system disclosed in '068 illuminates the side rails but fails to disclose illumination for the tailgate. As such, should the tailgate be in an open or downward position, the lighting means of '068 fails to illuminate the open tailgate, and therefore fails to identify to the driver following the pickup truck the location of the rearward end of the subject pickup truck.

U.S. Pat. No. 4,745,525 discloses a supplemental lighting system that is embedded into the tailgate of a pickup truck. While the lighting system of the '525 is visible when the tailgate is in a closed position, the lighting system is hidden when the tailgate is in an open position. As such, when the tailgate is in an open position, the lighting system of '525 is hidden from the driver of the vehicle following the subject pickup truck. As such, the lighting means disclosed in '525 again fails to illuminate the open tailgate, and therefore fails to identify to the driver following the pickup truck the location of the rearward end of the subject pickup truck.

The illuminating system according to the present invention departs from the conventional concepts and designs of the prior art, and in doing so, provides a lighting system primarily developed for the purpose of illuminating the tailgate of the vehicle whether the tailgate is in an open or closed position. It should be appreciated that there exists a continuing need for a new and improved illuminating system used for vehicles having a tailgate such as pickup trucks. In this regard, the present invention substantially fulfills this need.

### SUMMARY OF THE INVENTION

The present invention is a lighting system for illuminating a tailgate of a vehicle. The lighting system is generally attached to a top end portion of a tailgate of the vehicle. The lighting system includes a lighting element, which lighting element can be electrically connected to the vehicle's lighting system, so that when lights of the vehicle are turned on, the lighting element of the lighting system likewise illuminates. The lighting system can further include a sensor means, wherein the sensor means activates the lighting system to illuminate the lighting element upon the happening of a selected event, such as lowering the tailgate, or at darkness, dusk, or times of severe weather conditions, for example. The lighting element may be a single component, or, may consist of a plurality of lighting elements selectively positioned along the length of the top end of the tailgate.

The lighting element illuminates light in an upward direction when the tailgate is in the closed position. As such, in addition to positioning the lighting element along the top end of the tailgate, the lighting element can further extend along the length of the upper portion of the exterior wall of the tailgate. When the tailgate is in the open position, the lighting system illuminates light from the extended top end of the vehicle. As such, when the tailgate is in the open position, the lighting element illuminates light in a direction easily detectable by the vehicle following the vehicle.

### BRIEF DESCRIPTION OF THE DRAWINGS

FIG. 1 illustrates a perspective view of the lighting system of the present invention attached to the tailgate of a vehicle, the tailgate being in an open position.

FIG. 2 illustrates a rear view of the lighting system of FIG. 1.

FIG. 3 illustrates a perspective view of the lighting system disclosed in FIG. 1, the tailgate being in a closed position.

FIG. 4 illustrates an enlarged view of an alternate embodiment of the lighting system of FIG. 1.

FIG. 5 illustrates an alternate embodiment of the present invention.

FIG. 6 illustrates a second alternate embodiment of the present invention.

FIG. 7 illustrates a perspective view of the lighting system of FIG. 5.

FIG. 8 illustrates the lighting system of FIG. 6 attached to the tailgate of a vehicle, the tailgate being in an open position.

### DESCRIPTION OF THE PREFERRED EMBODIMENTS

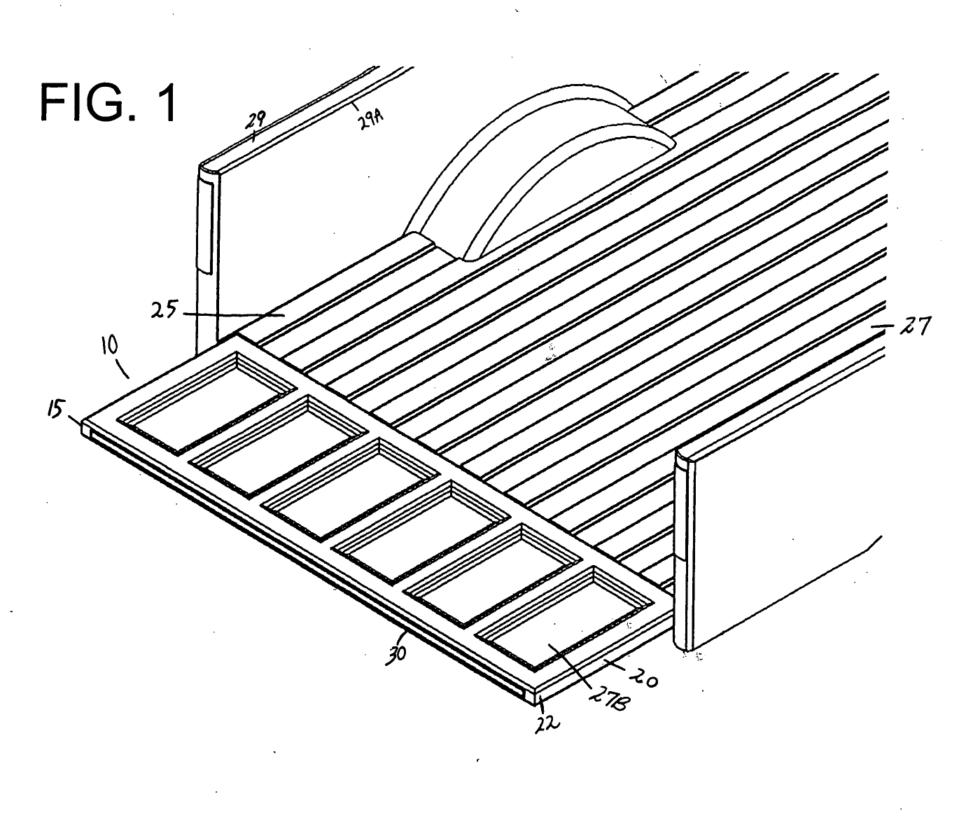

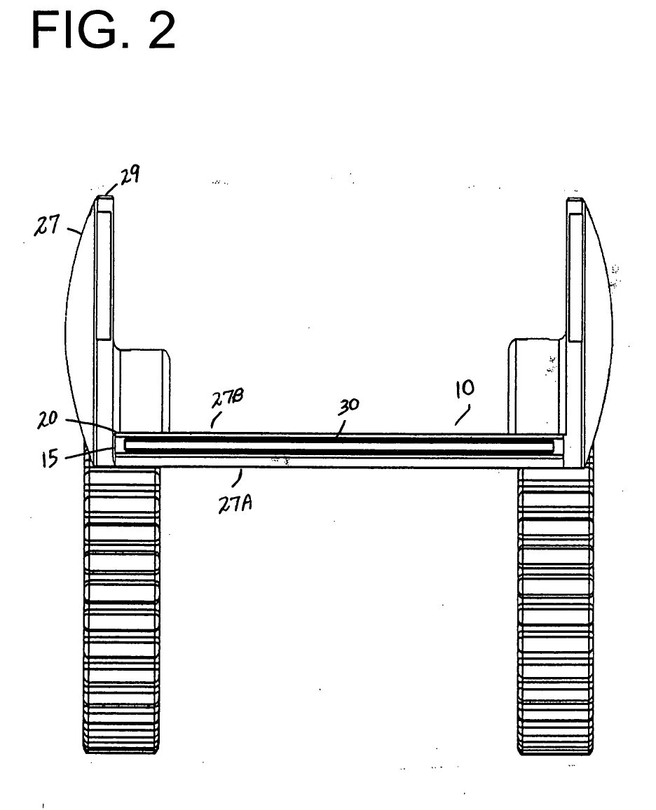

FIGS. 1-3 illustrate a preferred embodiment of a lighting system 10 made in accordance with the present invention. The lighting system 10 is generally attached to an end surface 15 of a tailgate 20 of a vehicle 27. The lighting system 10 substantially extending along a length of the end surface 15 of the tailgate 20.

As shown in the drawings, the tailgate 20 is a generally rectangular hollow structure which includes an exterior wall 27A, an interior wall 27B, the end surface 15 and a bottom end 16. Designators 29 refer to the top rails of the side panel of the vehicle 27 to better depict the environment of the invention. However, the side panels are not apart of the invention.

The lighting system 10 of the present invention includes a lighting element 30. In the preferred embodiment the lighting element 30 is electrically connected to the conventional lighting system (not shown) of the vehicle 27, so that when lights of the vehicle 27 are turned on, the lighting element 30 of the illuminating system 10 likewise illuminates. In this regard, application of all or any of the vehicle 27 lights, such as headlights, brake lights, warning lights, or reverse taillights may activate the lighting element 30.

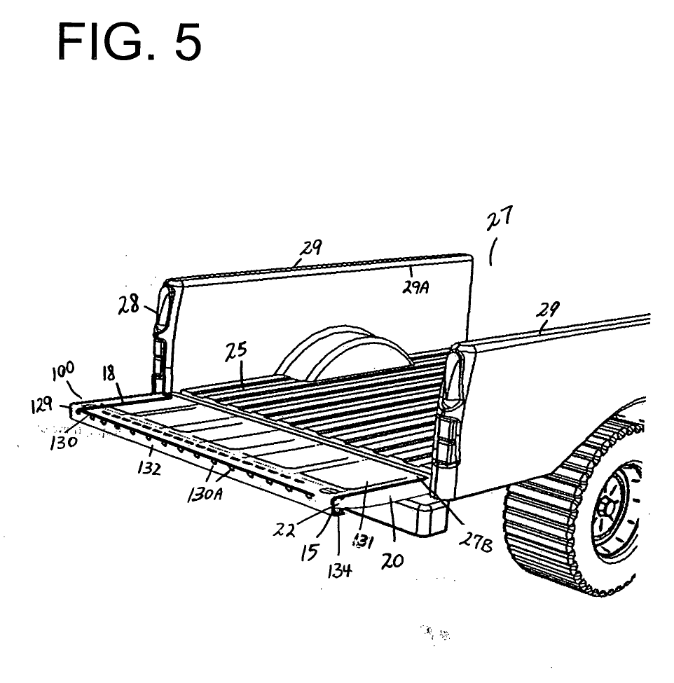

The lighting system 10 is preferably wired by running a plurality of wires 18 (shown in FIG. 5) between the lighting element 30 and the lighting system of the vehicle 27. Referring to FIG. 5, illustrates the wires 18 running between the lighting element and brake light 28 of the vehicle 27.

Alternatively, the lighting system 10 may further include a power source (not shown), such as a battery.

According to a preferred embodiment of the invention, the lighting element 30 is sized such that it fits on the end surface 15 of the tailgate 20, and does not extend substantially beyond the width and length of the end surface 15. In this manner, the lighting element 30 is protected from accidental damage caused by contact with objects (not shown) contained for example, within the vehicle's bed 25.

The lighting system 10 can further include a sensor means (not shown) known in the art, wherein the sensor means activates the lighting system 10 to illuminate the lighting element 30 upon the happening of a selected event. Such selected event may include the lowering of the tailgate 20, so that when the tailgate 20 is in the open position, the sensor means would activate the lighting system 10 and the lighting element 30 would illuminate. The sensor means may also activate the lighting system 10 during darkness, at dusk, or during times of severe weather conditions, for example.

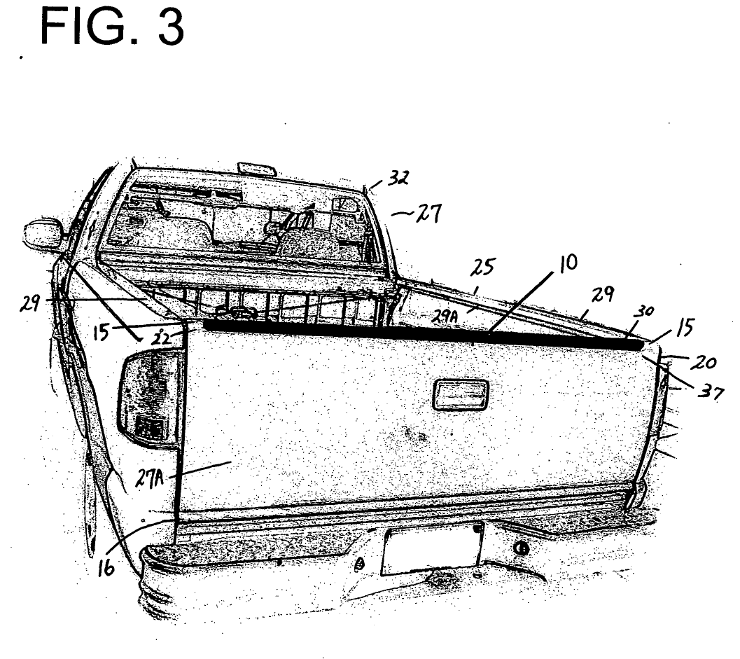

As described, the lighting element 30 illuminates light in an upward direction when the tailgate 20 is in the closed position. The lighting element 30, as shown in FIG. 3, can be further disposed along an upper portion 37 of the exterior wall 27A of the tailgate 20. As such, the lighting element 30 will also illuminate outwardly from the rear end portion of the vehicle 27 when the tailgate 20 is in the closed position.

When the tailgate 20 is in the open position, the lighting system 10 illuminates light from the outwardly extended end surface 15 of the tailgate 20 of the vehicle 27. As such, when the tailgate 20 is in the open position, the lighting element 30 illuminates light in a direction easily detectable by the vehicle following the vehicle 27. Likewise, when the tailgate 20 is in the closed position, the lighting system 10 illuminates light from the upper portion 37 of the exterior wall 27A of the tailgate 20. As such, when the tailgate 20 is in the closed position, the lighting element 30 illuminates light in a direction easily detectible by the vehicle following the vehicle 27.

When including the sensor means, the lighting system 10 is wired by running a plurality of wires (not expressly shown) between the lighting element 30 and the sensor means. The sensor means is coupled to the power source (i.e. battery) or to a fuse panel (not shown) of the conventional lighting system of the vehicle 27.

The wires 18 can run along the underside 29A of the top rails 29 of the bed 25 of the vehicle 27 and to the fuse panel which is generally located in the cab compartment 32 of the vehicle 27. When activated, current from the power source is generally directed through the battery or fuse panel, along the plurality of wires, and into the lighting element 30.

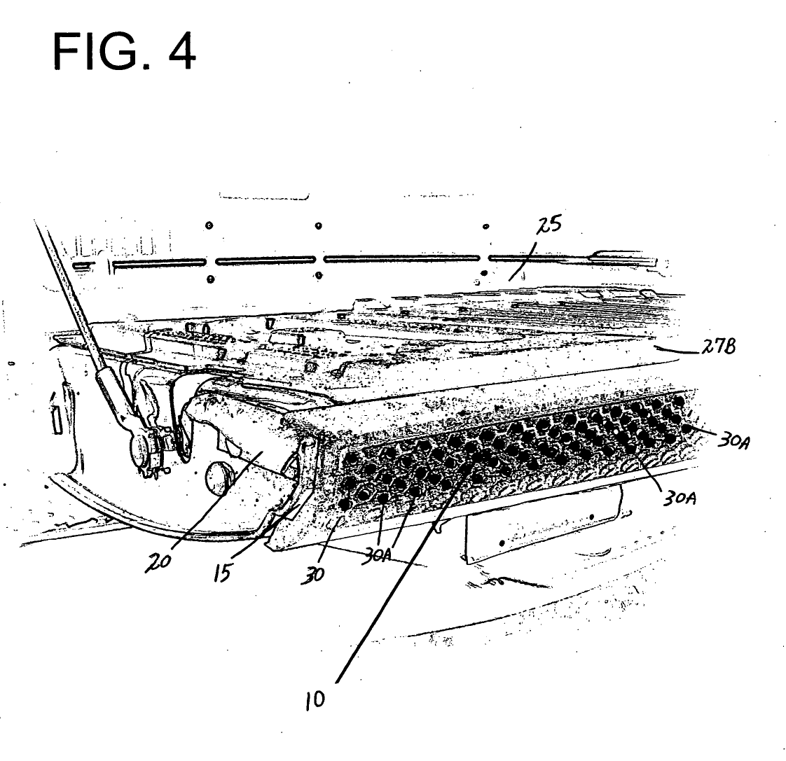

Different mechanisms for mounting the lighting element 30 to the tailgate 20 as described above may be utilized. Such mounting means are known in the art. Further, the lighting element 30 may be a single component that extends the axial length of the end surface 15 of the tailgate 20 shown in FIGS. 1, 2 and 3 or, may consist of a plurality of lighting elements 30A (shown in FIG. 4) selectively positioned along the length of the end surface 15 of the tailgate 20 and/or upper portion 37 of the exterior wall 27A of the tailgate 20. In addition, according to the present invention, different types of lighting elements 30 or 30A can be utilized. For example, strip lighting, LEDs, neon lights, halogen lights, etc., may be utilized.

It should be appreciated that the lighting system 10 is designed to either be factory installed or installed as an after-market accessory with minimal work and with no required modification to the shape or design of the tailgate 20 or vehicle bed 25. Further, the lighting system 10 may be engaged or disengaged from the vehicle 27 lighting system without effecting the operation of the vehicle 27 lighting system, or the raising or lowering of the bed's 25 tailgate 20.

FIGS. 5 and 7 illustrate an alternate embodiment of a lighting system 100. The lighting system 100 is attached to the tailgate 20 of the bed 25 of the vehicle 27. The lighting system 100 includes an L-shaped end portion 129 that includes a lighting element 130, and a liner portion 131. In application, the lighting element 130 substantially extends along the length of the end surface 15 of the tailgate 20.

As shown in the drawings, and as will be described, the L-shaped end portion 129 is attached to the tailgate 20, and the liner portion 131 rests on the interior wall 27B of the tailgate 20.

The lighting element 130 is electrically connected to the conventional lighting system (not shown) of the vehicle 27, so that when lights of the vehicle 27 are turned on, the lighting element 130 of the illuminating system 100 likewise illuminates. In this regard, application of all or any of the vehicle 27 lights, such as headlights, break lights, warning lights, or reverse tail lights may activate the lighting element 130. Referring to FIG. 5, illustrates the wires 18 running between the lighting element 130 and brake light 28 of the vehicle 27.

Referring to FIG. 7, the L-shaped end portion 129 includes a first surface 132, a second surface 133 and an opening 134, the opening 134 sized to received an upper end 22 (including the end surface 15) of the tailgate 20. As shown in FIG. 5, the end portion 129 is attached to the tailgate 20 by inserting the upper end 22 into the opening 134 and using attaching means such as threaded metal screws (not shown) or other means for attaching known in the art.

As shown in the drawings, the first surface 132 includes a plurality of lighting elements 130A (that form the lighting element 130) selectively positioned along the length of the first surface 132. When the tailgate 20 is in the open position (as shown in FIG. 5), the lighting element 130 disposed on the first surface 132 illuminates light from the outwardly extended end surface 15 of the tailgate 20 of the vehicle 27. As such, when the tailgate 20 is in the open position, the lighting element 130 illuminates light in a direction easily detectible by the vehicle following the vehicle 27.

While not shown in the drawings, the end portion 129 can further include the lighting element 130 selectively positioned along the length of the second surface 133. When the tailgate 20 is in the closed position, it should be understood the lighting system 100 illuminates light from the upper portion 37 of the exterior wall 27A of the tailgate 20. As such, when the tailgate 20 is in the closed position, the lighting element 130 disposed along the second surface 133 illuminates light in a direction easily detectable by the vehicle following the vehicle 27.

Different mechanisms for mounting the lighting system 100 to the tailgate 20 as described above may be utilized. Such mounting means are known in the art. In addition, different types of lighting elements 130 or 130A can be utilized. For example, strip lighting, LEDs, neon lights, halogen lights, etc., may be utilized.

It should be appreciated that the lighting system 100 is designed to be installed as an after-market accessory with minimal work and with no required modification to the shape or design of the tailgate 20 or vehicle bed 25. Further, the lighting system 100 may be engaged or disengaged from the vehicle 27 lighting system without effecting the operation of the vehicle 27 lighting system, or the raising or lowering of the bed's 25 tailgate 20.

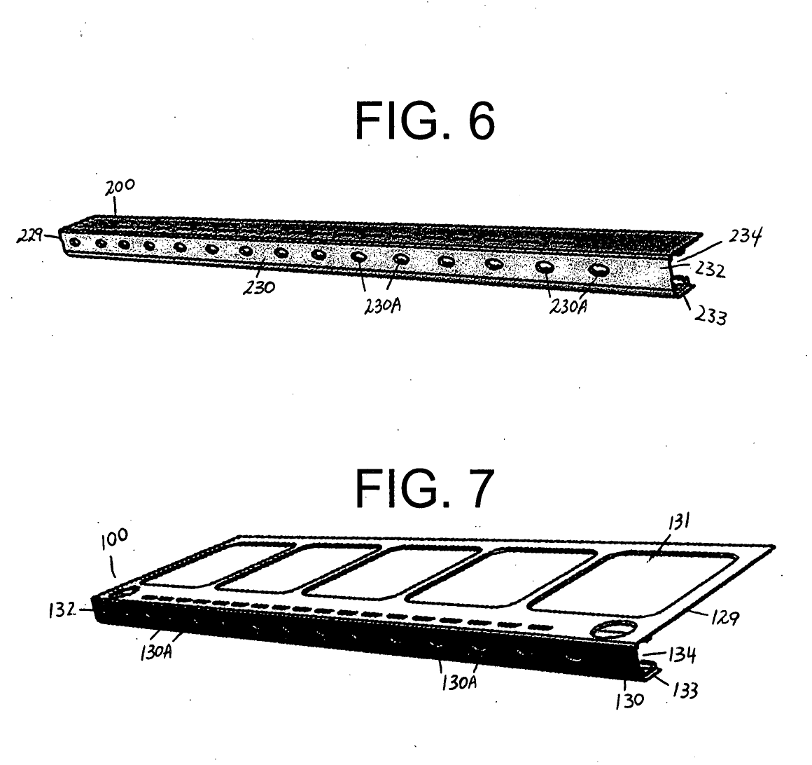

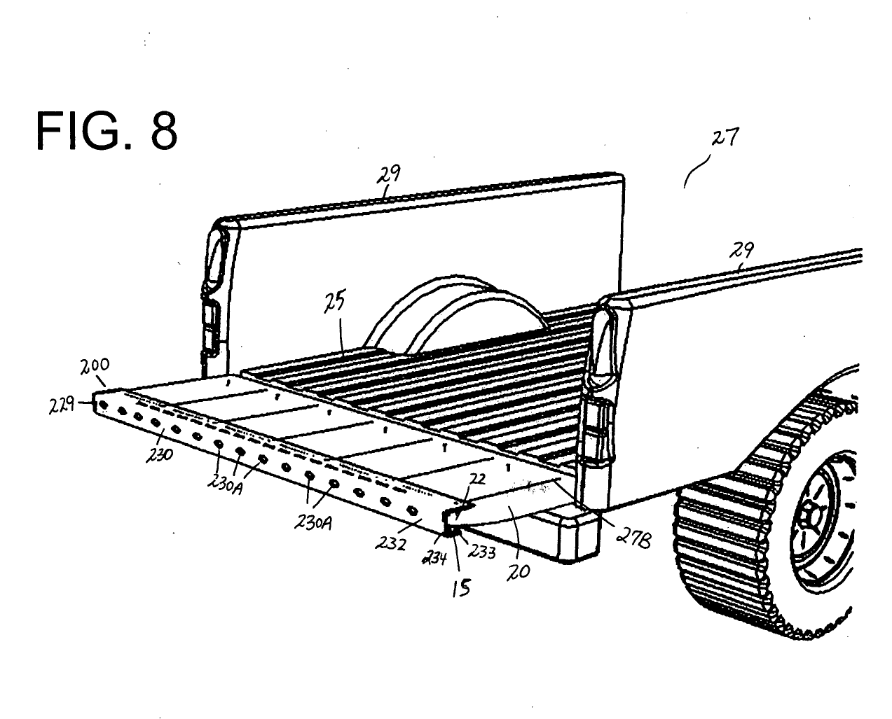

FIGS. 6 and 8 illustrate an alternate embodiment of a lighting system 200. The lighting system 200 is attached to the tailgate 20 of the vehicle 27. The lighting system 200 comprising a U-shaped cap 229 that includes a lighting element 230. In application, the lighting element 230 substantially extends along the length of the end surface 15 of the tailgate 20.

As shown in the drawings and as will be described, the U-shaped cap 229 is attached to the tailgate 20.

The lighting element 230 is electrically connected to the conventional lighting system (not shown) of the vehicle 27, so that when lights of the vehicle 27 are turned on, the lighting element 230 of the illuminating system 200 likewise illuminates. In this regard, application of all or any of the vehicle 27 lights, such as headlights, break lights, warning lights or reverse tail lights may activate the lighting element 230.

The U-shaped cap 229 includes a first surface 232, a second surface 233 and an opening 234, the opening 234 sized to receive the upper end 22 (including the end surface 15) of the tailgate 20. In particular, the end cap 229 is attached to the tailgate 20 by inserting the upper end 22 into the opening 234 and using attaching means such as threaded metal screws (not shown) or other means for attaching known in the art.

As shown in the drawings, the first surface 232 includes a plurality of lighting elements 230A (that form the lighting element 230) selectively positioned along the length of the first surface 232. When the tailgate 20 is in the open position the lighting element 230 disposed on the first surface 232 illuminates light from the outwardly extended end surface 15 of the tailgate 20 of the vehicle 27. As such, when the tailgate 20 is in the open position, the lighting element 230 illuminates light in a direction easily detectible by the vehicle following the vehicle 27.

While not shown in the drawings, the cap 229 can further include the lighting element 230 along the length of the second surface 233. When the tailgate 20 is in the closed position, it should be understood the lighting system 200 illuminates light from the upper portion 37 of the exterior wall 27A of the tailgate 20. As such, when the tailgate 20 is in the closed position, the lighting element 230 disposed along the second surface 233 of the cap 229 illuminates light in a direction easily detectible by the vehicle following the vehicle 27.

Different mechanisms for mounting the lighting system 200 to the tailgate 20 as described above may be utilized. Such mounting means are known in the art. In addition, different types of lighting elements 230 or 230A can be utilized. For example, strip lighting, LEDs, neon lights, halogen lights, etc., may be utilized.

It should be appreciated that the lighting system 200 is designed to be installed as an after-market accessory with minimal work and with no required modification to the shape or design of the tailgate 20 or vehicle bed 25. Further, the lighting system 200 may be engaged or disengaged from the vehicle lighting system without effecting the operation of the vehicle lighting system, or the raising or lowering of the bed's 25 tailgate 20.

Although the description above contains many specificities, they should not be construed as limiting the scope of the invention but as merely providing illustrations of some of the presently preferred embodiments of this invention.

Thus, the scope of the invention should be determined by the appended claims in the formal application and their legal equivalents, rather than by the examples given.

1. A lighting system for illuminating a tailgate of a vehicle, said lighting system comprising:
a power means,
a lighting element electrically connected to said power means,
wherein the lighting element is sized to fit on an end of the tailgate of the vehicle.

2. The lighting system as recited in claim 1, wherein the power means is a brake light of the vehicle.

3. The lighting system as recited in claim 1, wherein the power means is a fuse panel of the vehicle.

4. The lighting system as recited in claim 1, further including a sensor means, wherein said sensor means is coupled to said power means, and wherein said sensor means activates the lighting element upon the happening of an event.

5. The lighting system as recited in claim 1, further including a second lighting element, said second lighting element disposed along an upper portion of an exterior wall of the tailgate of the vehicle.

6. The lighting system as recited in claim 5, wherein said second lighting element is electrically connected to said power means.

7. The lighting system as recited in claim 1, wherein the lighting element illuminates light in a direction easily detectible by a following vehicle when the tailgate is in an open position.

8. The lighting system as recited in claim 5, wherein the second lighting element illuminates light in a direction easily detectible by a following vehicle when the tailgate is in a closed position.

9. A lighting system comprising:
a power means,
a structure having a first side and a second side,
a lighting element disposed along the length of the first side, said lighting element electrically connected to said power means,
wherein the structure is affixed to an extended portion of a vehicle.

10. The lighting system as recited in claim 9, wherein the power means is a brake light of the vehicle.

11. The lighting system as recited in claim 9, wherein the power means is a fuse panel of the vehicle.

12. The lighting system as recited in claim 9, further including a sensor means, wherein said sensor means is coupled to the power means, and wherein said sensor means activates the lighting element upon the happening of an event.

13. The lighting system as recited in claim 9, wherein the first side of the structure abuts a first surface of the extended portion, and the second side abuts a second surface of the extended portion.

14. The lighting system as recited in claim 13, further including a second lighting element disposed along the second side of the structure.

15. The lighting system as recited in claim 14, wherein said second lighting element is electrically connected to said power means.

16. The lighting system as recited in claim 9, wherein the lighting element illuminates light in a direction easily detectible by a following vehicle when the extended portion is in an open position.

17. The lighting system as recited in claim 14, wherein the second lighting element illuminates light in a direction easily detectible by a following vehicle when the extended portion is in a closed position.

18. The lighting system as recited in claim 9, wherein the lighting element comprising a plurality of individual lights.

19. The lighting system as recited in claim 9, wherein the lighting element is a strip lighting.
